(19) United States
(12) Patent Application Publication
(10) Pub. No.: US 2003/0060222 A1
(43) Pub. Date: Mar. 27, 2003

(54) Network access point with auxiliary transceiver

(76) Inventor: Johan Rune, Lidingo (SE)

Correspondence Address: BURNS DOANE SWECKER & MATHIS L L P, POST OFFICE BOX 1404, ALEXANDRIA, VA, 22313-1404, US

(21) Appl. No.: 09/961,246

(22) Filed: Sep. 25, 2001

(51) Int. Cl. H04B 7/00

(52) U.S. Cl. 455/517; 455/41

(57) ABSTRACT

One or more auxiliary transceivers are provided in a Bluetooth network access point (NAP). Use of additional auxiliary transceivers allows the operations of the Bluetooth technology to be performed in an efficient manner. The auxiliary transceivers perform the tasks of page scan, including connection establishment, and inquiry scan, including inquiry response. Numerous transceivers and arrangements for performing these tasks may be employed.

### FIELD OF THE INVENTION

The present invention relates to a Network Access Point (NAP). More particularly, the present invention relates to the utilization of Bluetooth technology in a NAP.

### BACKGROUND OF THE INVENTION

Bluetooth was originally designed to eliminate the necessity for cables that connected various electronic devices. In eliminating the need of cables, various devices would have greater freedom of movement and versatility where it connected and to what other devices it connected to.

Today, Bluetooth is an open specification for wireless communication of both voice and data. It uses a frequency hoping scheme and operates in the 2.4 GHz Industrial-Scientific-Medical (ISM) band. It is based on a short-range, universal radio link, and it provides a mechanism to form small ad-hoc groupings (nodes that join together to form a network) of connected devices, without a fixed network infrastructure, including such devices as printers, personal digital assistants (PDAs), desktop computers, FAX machines, keyboards, joysticks, telephones or virtually any digital device.

Within Bluetooth various devices are seperated in different master-slave relationships. A piconet is a collection of two or more digital devices, such as any of those mentioned above, hereinafter referred to as Bluetooth devices, connected using Bluetooth technology in an ad-hoc fashion. A piconet can include up to eight Bluetooth devices. In each piconet there exists one master Bluetooth unit and one or more slave Bluetooth units. Any device within the Piconet may become a master of the Piconet. FIG. 1 illustrates a Bluetooth piconet having a master unit 101 connected to slave unit 102.

According to the Bluetooth specification a slave unit can only communicate directly with a master unit. FIG. 2 illustrates a piconet with a master unit 201 and a plurality of slave units 202-208 arranged in a star network topology. If, for example, slave unit 202 wishes to communicate with slave unit 206, slave unit 202 would have to transmit the information it wished to communicate to master unit 201. Master unit 201 would then transmit the information to slave unit 206.

A scatternet is formed by multiple independent and unsynchronized piconets. To implement a scatternet it is necessary to use nodes which are members of more than one piconet. Such nodes are herein referred to as forwarding nodes. FIG. 3 illustrates an exemplary scatternet 300. In FIG. 3, piconet 1 includes a master node 303 and the slave nodes 301, 302 and 304; piconet 2 includes the master node 305 and the slave nodes 304, 306, 307 and 308; and piconet 3 includes the master node 309 and the slave nodes 308, 310 and 311. As can be seen in FIG. 3, nodes 304 and 308 are forwarding nodes. If, for example, node 301 in piconet 1 wishes to communicate with node 310 in piconet 3, then nodes 304 and 308 might act as forwarding nodes that facilitate this communication by forming a connection between the two piconets and in particular between nodes 301 and 310. For example, node 301 transfers the information to the master node 303 of piconet 1. Master node 303 transmits the information to forwarding node 304. Forwarding node 304 then forwards the information to master node 305 of piconet 2, which in turn, transmits the information to forwarding node 308. Forwarding node 308 forwards the information to master node 309 of piconet 3 which transmits the information to the destination node 310.

Bluetooth may also be used to provide a flexible wireless access to a fixed infrastructure. The fixed infrastructure could be e.g. a corporate LAN or a network operated by an Internet Service Provider (ISP). Devices utilizing wireless access can leverage its inherent flexibility to be mobile devices. A device connected to a fixed network, providing wireless access to wireless devices, is denoted as a Network Access Point (NAP). A Bluetooth NAP uses the technology of the fixed network on its fixed side and Bluetooth technology on its wireless side. The concept could be enhanced to let wireless devices roam between different NAPs. If connection or data flows survive a switch between two NAPs, this is called a “hand-over”. A Bluetooth NAP would preferably be the master of its own piconet. In this way, the Bluetooth NAP can control the traffic processing by polling the slave units in an efficient manner. If the NAP were a slave unit, it would have to switch between different piconets in order to be polled by the connected devices, which is very inefficient.

Each Bluetooth unit has a globally unique address called the Bluetooth Device Address (BD_ADDR). This address is assigned when the Bluetooth unit is manufactured. In addition, the master of a piconet assigns a local Active Member Address (AM_ADDR) to each active member of the piconet. The AM_ADDR is dynamically assigned and de-assigned and is unique only within a single piconet. The master uses the AM_ADDR when polling a slave and the slave uses it when transmitting to the master.

The combination of Bluetooth technology with a NAP allows, for example, a corporation to utilize the flexibility of Bluetooth's mobile communications with a NAP for use in corporate LAN. The LAN may employ one or several NAPs. It is important for the NAP to be discoverable. In other words, roaming devices such as laptops, PDAs, etc. and other Bluetooth devices can establish links with the LAN via the LAN's NAP(s), but these Bluetooth devices must be able to find the NAP in order to establish a communication link with the NAP.

In order to make itself known to various roaming devices etc., the NAP must regularly spend time in an inquiry scan state, scanning the area for communications from possible devices requesting responses from the NAP. Discovering a scanning device can take up to 10 seconds, according to present specifications. This delay is unacceptable to many roaming device users. Further, this delay can create problems associated with the handover procedure in which the established connection is handed over from one NAP to another.

A possible way of reducing the delay time would be to increase the amount of time spent in the inquiry scan state. However, this would reduce the NAP's time spent performing its primary function, which is the relay of traffic between various roaming devices and the network. Reducing the time spent on the NAP's primary function would only degrade the quality of service experienced by users and applications.

Accordingly, a need exists to increase the speed with which NAPs and roaming devices discover each other and establish communication, while maintaining, without adversely affecting, high rates of data transfer between NAPs and roaming devices.

### SUMMARY OF THE INVENTION

These and other problems, drawbacks and limitations of conventional techniques are overcome according to the present invention by the Bluetooth NAP of the present invention.

Accordingly, it is an objective of the present invention to provide at least one auxiliary transceiver in addition to a traffic transceiver used by the Bluetooth NAP. The auxiliary transceivers allow the Bluetooth NAP to delegate tasks to the various auxiliary transceivers, thereby diminishing the burden on the traffic transceiver. Thus, the Bluetooth NAP is more efficient and faster.

In accordance with one aspect of the present invention, the foregoing and other objects are achieved by a method of using two auxiliary transceivers. The first auxiliary transceiver performs the duties associated with inquiry scans, while the second auxiliary transceiver performs the duties associated with page scan.

### BRIEF DESCRIPTION OF THE DRAWINGS

The objects and advantages of the invention will be understood by reading the following detailed description in conjunction with the drawings in which:

FIG. 1 illustrates an exemplary Bluetooth piconet.

FIG. 2 illustrates an exemplary star-topology network in a Bluetooth piconet.

FIG. 3 illustrates an exemplary Bluetooth scatternet formed by a plurality of piconets.

FIG. 4 illustrates an exemplary Bluetooth NAP network.

FIG. 5 illustrates an exemplary Bluetooth NAP with two auxiliary transceivers.

FIG. 6 illustrates an exemplary message sequence for a first procedure for handing over a connection from the page scan receiver to the traffic transceiver.

FIG. 7 illustrates an exemplary message sequence for a second procedure for handing over a connection from the page scan receiver to the traffic transceiver.

FIG. 8 illustrates an exemplary message sequence for a third procedure for handing over a connection from the page scan receiver to the traffic transceiver.

FIG. 9 illustrates an exemplary Bluetooth NAP with one auxiliary transceiver.

FIGS. 10-12 illustrate exemplary Bluetooth NAP's having multiple auxiliary transceivers.

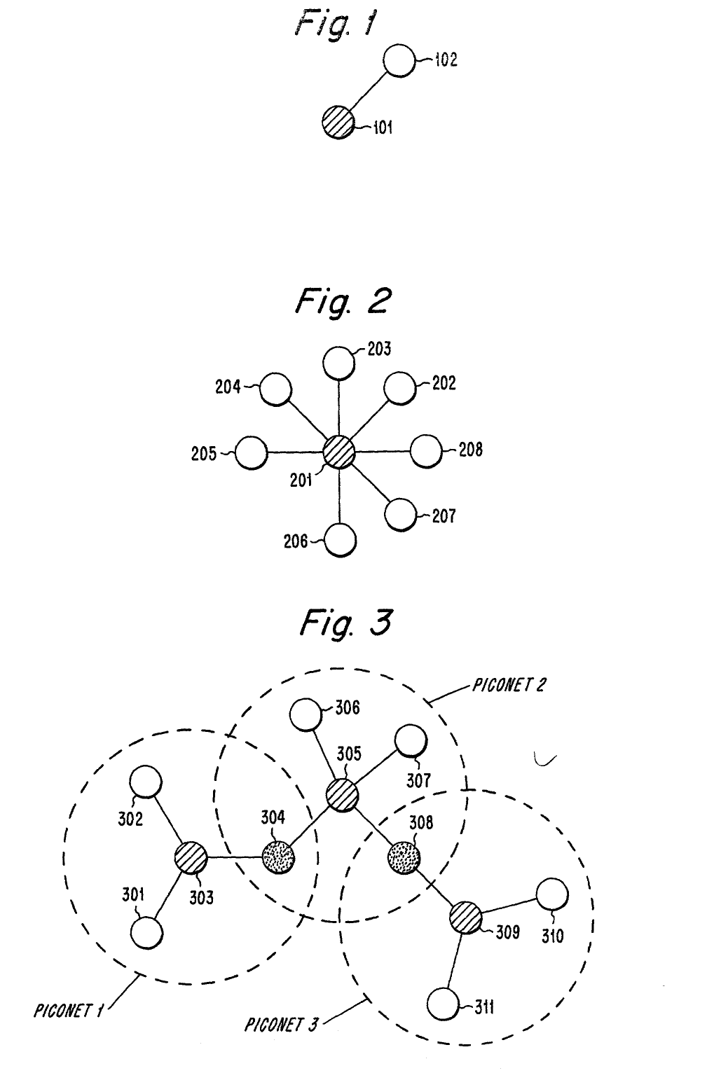

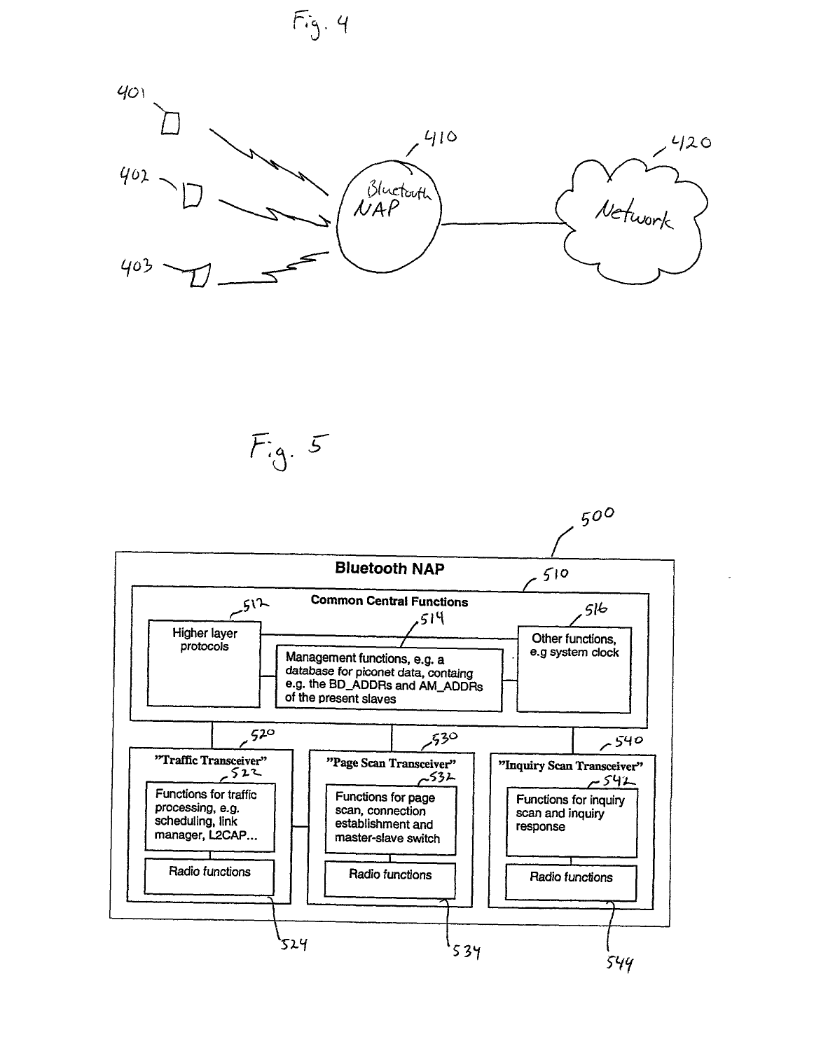

### DETAILED DESCRIPTION

The use of a wireless NAP which uses the Bluetooth technology may cause unwanted delays in the discovery process (process of a wireless device attempting to discover NAPs in the area, i.e., within radio range). Other problems, such as creating disturbances in the handover process also may occur. Therefore, providing an efficient network access method and process is desirable. In order to achieve the above desired results, the present invention provides a NAP having auxiliary transceivers attached thereto. The use of auxiliary transceivers relieves the main receiver from performing tasks such as inquiry scans and page scans. This allows each individual receiver to focus on a specific task and not on performing several tasks thereby increasing the efficiency and minimizing the delay associated with NAPs having no auxiliary transceivers. The auxiliary transceivers used by the NAP may be any number of transceivers. However, for purpose of discussion of the present invention, exemplary embodiments of a NAP with two auxiliary transceivers is specifically addressed.

The NAP according to the present invention is not an ordinary Bluetooth device. The NAP has several characteristics which distinguish it from many Bluetooth devices. First, the Bluetooth NAP of the present invention is part of a network infrastructure. Second, the Bluetooth NAP can communicate directly with other NAPs connected to the same network. Finally, the Bluetooth NAP may be connected to an external power supply (plugged into a wall outlet) instead of being limited by an internal battery, as is the case of mobile Bluetooth devices. Although the Bluetooth NAP can be mobile, it generally does not need to be moved regularly and thus battery power is not necessarily needed.

FIG. 4 provides an overview of a Bluetooth NAP network. The Bluetooth NAP 410 is connected to a network 420, such as a LAN. Roaming mobile Bluetooth units 401, 402 and 403 connect to the Bluetooth NAP 410 which acts as a gateway to the network 420. FIG. 4 illustrates an electronically wired infrastructure, i.e. the Bluetooth NAP hardwired to the network. Alternatively, an wireless connection between the NAP 410 and the Network 420 may be employed.

In a preferred embodiment, the Bluetooth NAP has attached thereto two auxiliary transceivers. When two transceivers are used, the main transceiver, known as the traffic transceiver, concentrates on performing the tasks associated with processing traffic. The two auxiliary transceivers, referred to as the inquiry scan transceiver and the page scan transceiver, focus on only performing the tasks associated with inquiry scan and page scan, respectively.

In contrast, conventional known NAPs that support Bluetooth operations utilize a single transceiver to perform all the various tasks, i.e. inquiry scan, page scan and traffic processing. Therefore, in order for the various roaming Bluetooth devices to recognize the Bluetooth NAP of the present invention as a single Bluetooth device, it is necessary to share the same BD_ADDR (Bluetooth device address) among the main and auxiliary transceivers. The BD_ADDR is a unique Bluetooth ID number for each device which is assigned to every Bluetooth device at the time of manufacture and is never changed. Also, each one of the transceivers must be synchronized to the same internal clock. In other words, the main and auxiliary transceivers are synchronized and have the same codes, identities and in another exemplary embodiment, the same frequency hop sequence. However, since different frequency hop sequences are used for different tasks in different states, for example, traffic processing in the connection state, inquiry scan in the inquiry scan state and page scan in the page scan state, in a preferred embodiment the different transceivers will use different frequency hop sequences.

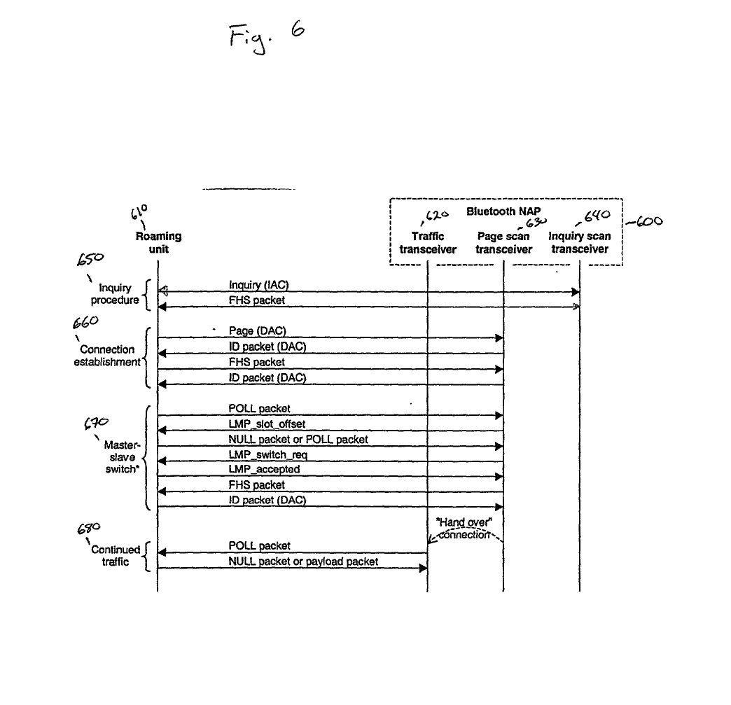

An exemplary illustration of a Bluetooth NAP 500 is shown in FIG. 5. The Bluetooth NAP 500 is comprised of a common central unit 510 in which all the functions central to the operation of the Bluetooth NAP 500 are located. These functions include but are not limited to processing higher layer protocols 512, providing management functions 514, e.g. managing a database of Bluetooth device addresses BD_ADDR and active member addresses AM_ADDR and handling all other functions 516 such as the system clock etc. Connected to the common central unit 510 are the transceivers. These include the main transceiver or traffic transceiver 520 and the two auxiliary transceivers or page scan and inquiry scan transceivers, 530 and 540 respectively. Within each of the transceivers are elements for controlling the functions associated with the particular processes of each transceiver and the radio communications. For example, the traffic transceiver 520 has a function element 522 that controls such things as scheduling, link managing and logical link control and adaptation protocol (L2CAP). The page scan transceiver 530 provides functions 532 for page scan and connection establishment etc. Also, the inquiry scan transceiver 540 provides a function element 542 that pertains to inquiry scan and response. Each of these transceivers 520, 530 and 540, contain radio functions 524, 534 and 544 which control the reception and transmission of radio signals.

The functionality of the inquiry scan transceiver is independent of the traffic and page scan transceivers. The basic operation of the inquiry scan transceiver involves the collection of inquiry messages from roaming Bluetooth devices and sending responses to the received inquiry messages. Alternately, the inquiry scan transceiver may function as an “inquiry transceiver” by sending out inquiry messages indicating to other roaming Bluetooth devices where the Bluetooth NAP is located. However, in a preferred embodiment of the present invention, the inquiry scan transceiver scans the area for inquiries from Bluetooth roaming devices and does not transmit any inquiry messages of its own. Communication with the other transceivers is unnecessary. The inquiry scan transceiver scans for inquiry messages and responds to the inquiries detected without communicating with the other transceivers in the Bluetooth NAP. In responding to the detected inquiries, an inquiry response message is transmitted that contains information concerning the Bluetooth NAP, i.e. clock, BD_ADDR etc. After obtaining this information the Bluetooth roaming device may transmit to the page scan transceiver.

The page scan transceiver is responsible for establishing a connection with the Bluetooth roaming unit. Once the establishment has been made, then the page scan transceiver may “hand over” the connection to the traffic transceiver. It should be noted that this “hand over” is internal to the NAP and the roaming unit is not affected in any way. In order for the internal hand over to take place, the connection state frequency hop sequence of the Bluetooth NAP must be used. The connection state frequency hop sequence is the hop sequence used in the piconet where the Bluetooth NAP is the master. However, since it is usually the Bluetooth roaming unit that establishes a connection with the page scan transceiver, it is the Bluetooth roaming unit that is considered the master of the new piconet created between the Bluetooth roaming unit and the Bluetooth NAP. Thus, it is necessary to perform a master-slave switch, in which the Bluetooth NAP is designated as the master. The master-slave switch may be performed by the page scan transceiver.

In accomplishing the internal hand-over procedure, there are several alternative message sequences that may be performed. FIG. 6 illustrates an exemplary embodiment of a first alternative procedure. The Bluetooth roaming unit 610 transmits an inquiry which is received by inquiry scan transceiver 640. In response, the inquiry scan transceiver 640 transmits an FHS packet to the Bluetooth roaming unit 610. This is accomplished in the inquiry procedure 650. Once the inquiry procedure 650 has been performed, then a connection establishment procedure/process 660 is performed. During the connection establishment 660 the Bluetooth roaming unit 610 communicates with the page scan transceiver 630. Information necessary to establish a connection between the Bluetooth NAP 600 and the Bluetooth roaming unit 610 is exchanged during the connection establishment 660 procedure/process.

In the connection establishment 660 procedure/process, the page packet transmitted from the Bluetooth 610 consists of the DAC (Device Access Code) of the Bluetooth NAP 600. The Bluetooth NAP 600, responds with a packet consisting of the same DAC 610. In general, a packet that consists of only a DAC is referred to as an “ID packet”. The Bluetooth roaming unit 610 then sends the FHS packet which contains information necessary to establish a connection, such as the BD_ADDR, current value of the internal clock, AM ADDR, etc. The Bluetooth NAP 600 then responds by sending an ID packet containing it's own DAC which confirms the reception of the FHS packet. The Bluetooth NAP 600 and the Bluetooth roaming unit 610 can now enter the connection state with the roaming unit 610 as the master and the Bluetooth NAP 600 as the slave.

A master-slave switching process 670 is performed after the connection between the Bluetooth roaming unit 610 and the Bluetooth NAP 600 is established. A POLL packet is sent from the roaming unit 610 to the Bluetooth NAP 600 which initiates the master-slave switching process 670. As illustrated above, the roaming unit 610 is the master, and the Bluetooth NAP 600 (specifically, the page scan transceiver 630) is the slave. To perform the master-slave switch, various information is transferred between the two devices. First, the Bluetooth roaming unit 610 sends a POLL packet to the page scan transceiver 630. A POLL packet may be used to poll slaves in an established piconet. The slave must answer to a POLL packet. Thus, the page scan transceiver 630 responds to the POLL packet by providing link management protocol (LMP) data. Information is sent back and forth in this manner. During the master-slave switch 670, the Bluetooth NAP 600, transfers the precise time differences between the start of an even time slot according to the Bluetooth NAP 600 clock and the start of an even time slot according to the roaming units 610 clock. The Bluetooth NAP 600 can calculate this difference because it determines the clock of the roaming unit 610 from the arrival times of the packets received from the roaming unit 610 and compares this with its own internal clock. However, the roaming unit 610 does not know the clock of the Bluetooth NAP 600 with the same accuracy and therefore, the Bluetooth NAP 600 transfers this information to the roaming unit 610. With the clock information of the Bluetooth NAP 600 the roaming unit 610 will know exactly when to listen for packets from the Bluetooth NAP 600 after the master-slave switch has been completed. The time difference information is transferred in the LMP_slot_offset PDU. The roaming unit 610 then responds with a NULL packet or a POLL packet which confirms or negatively acknowledges the reception of the LMP_slot_offset PDU. The Bluetooth NAP 600 then sends a LMP_switch_req PDU to the roaming unit 610, requesting a master-slave switch. The only data contained in the LMP_switch req PDU is the time instant of the subsequent switch, expressed as the value of the clock of the roaming unit 610 when the switch will take place. The roaming unit 610 accepts the requested master-slave switch by responding with a LMP accepted PDU. The Bluetooth NAP 600 then sends a FHS packet to the roaming unit 610. The FHS packet contains, among other data, the clock and BD_ADDR of the Bluetooth NAP 600, which allows the roaming unit 610 to derive the frequency hop sequence which will be used after the master-slave switch. The FHS packet also contains the AM_ADDR which has been assigned to the roaming unit 610 by the Bluetooth NAP 600. The master-slave switch is completed when the roaming unit 610 confirms the reception of the FHS packet by transmitting an ID packet consisting of its DAC and thus, a new master-slave condition is created where the Bluetooth NAP 600 is the master and the Bluetooth roaming device 610 is the slave. It should be noted that other master-slave switch procedures different from the above described master-slave switch procedures as described in the specification core 1.0b, hereby incorporated by reference, may be used. The connection state frequency hop sequence of the Bluetooth NAP may now be used. Once the master-slave switch 670 has been completed the connection is internally handed over from the page scan transceiver 630 to the traffic transceiver 620 and the first packet to be transmitted is a POLL packet from the Bluetooth NAP 600 which initiates the traffic 680 between the Bluetooth NAP 600 and the roaming unit 610.

As described above, prior to handing over the connection to the traffic transceiver, the new Bluetooth roaming slave is assigned an active member address AM_ADDR. The active member address AM_ADDR is used to identify the Bluetooth roaming slave and distinguish it from other active members participating on the piconet. Each slave is assigned a temporary address which is used to identify the slave when the slave is active. These temporary addresses allow the master to separately identify each slave in the piconet. Each packet that is exchanged between a master and a slave carries the AM_ADDR of the slave.

In order to handover the connection to the traffic transceiver the only information that the page scan transceiver needs to transfer to the traffic transceiver is the AM_ADDR. However, if necessary, the traffic transceiver may also transfer the BD_ADDR. Once this information has been transferred to the traffic transceiver, the Bluetooth roaming unit is included in the scheduling tables of the traffic transceiver. This allows the traffic transceiver to begin polling the new slave. The Bluetooth specification requires the traffic transceiver to poll the new slave within a determined number of time slots after the DAC concluding the master-slave switch is sent, otherwise the connection will be lost. The default number of time slots is 32 time slots, however, this can change depending on the particular system. The parameter for defining this time slot is defined in the Bluetooth Core 1.0b and Core 1.1 specifications, which are hereby incorporated by reference.

After the master-slave switch has been performed, the connection is internally “handed over” to the traffic transceiver 620. Once the connection is under the control of the traffic transceiver, traffic regulation and control 680 is maintained and performed. At this point direct communication can take place between the Bluetooth roaming unit 610 and the Bluetooth NAP 600. Any data or information may be transferred or received.

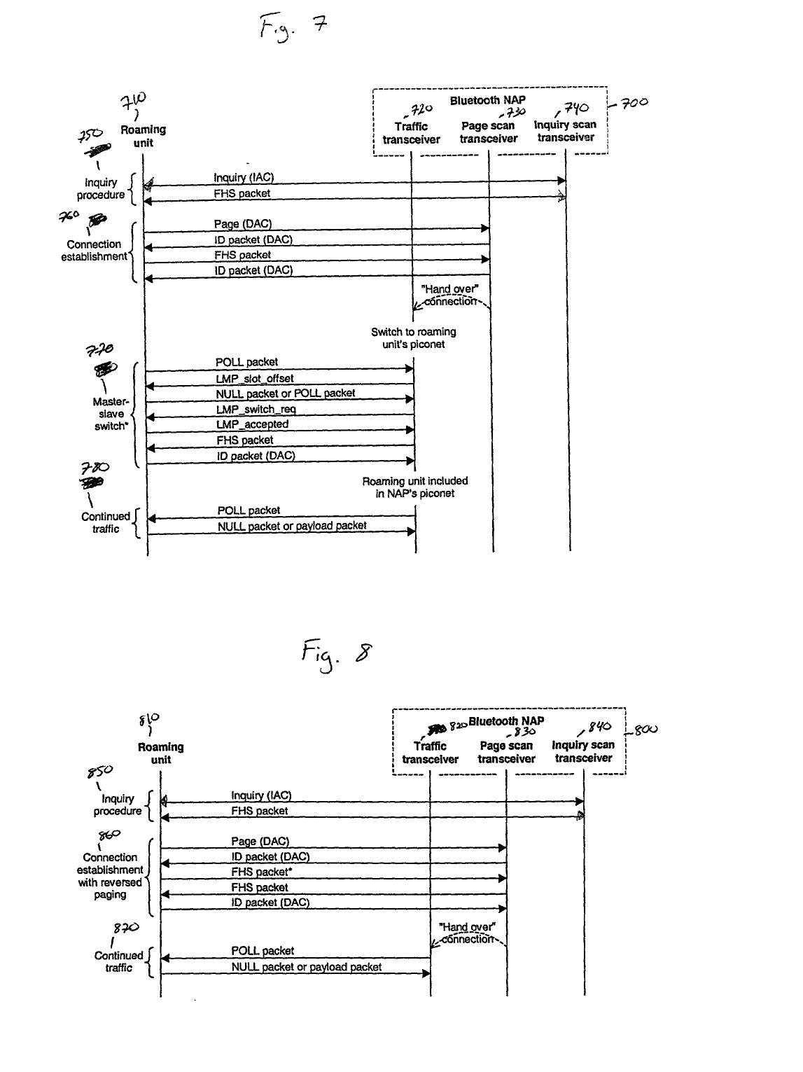

In a second alternative message sequence shown in FIG. 7, the page scan transceiver internally hands over the connection to the traffic transceiver prior to performing the master-slave switch. The internal hand over to the traffic transceiver takes place as soon as the connection has been established, i.e, when the page scan transceiver has sent its last DAC message to the Bluetooth roaming unit. To inform the traffic transceiver of the new connection, the page scan transceiver must also transfer all relevant information that it received in the FHS packet from the Bluetooth roaming unit, including the clock and BD_ADDR of the Bluetooth roaming device. The page scan transceiver must also transfer the precise difference between the start of an even time slot according to the clock of the Bluetooth roaming unit and the start of an even time slot according to the clock of the Bluetooth NAP. This is done (a) so that the traffic transceiver can derive the frequency hop sequence that is to be used when communicating with the Bluetooth NAP, and (b) to inform the Bluetooth NAP of the exact timing of the piconet in which the Bluetooth roaming unit is the master.

As illustrated in FIG. 7, the roaming unit 710 performs an inquiry scan 750 with the inquiry scan transceiver 740. A connection establishment process 760, which is the same as the connection establishment 660 in FIG. 6, is then performed to establish a connection between the page scan transceiver 730 and the Bluetooth roaming device. After the connection has been made, the page scan transceiver 730 internally hands the connection over to the traffic transceiver 720. The traffic transceiver 720 switches to the Bluetooth roaming unit's 710 piconet in order to perform a master-slave switching process 770. The master-slave switch process 770 is the same as the master-slave switch procedure 670 described above, but takes place between the traffic transceiver 720 and the roaming unit 710 instead of between the page scan transceiver and the roaming unit. Once the master-slave switch 770 has been performed, the Bluetooth roaming unit becomes part of the Bluetooth NAP's 700 piconet. Thereafter, the Bluetooth NAP 700 and the traffic transceiver 720 can perform operations normally associated with a connected Bluetooth roaming unit as indicated by the continued traffic 780.

In a third exemplary embodiment of the invention, which is illustrated in FIG. 8, the Bluetooth NAP becomes the master of the Bluetooth roaming unit through a reversed paging procedure, as described in U.S. patent application Ser. No. 09/729,926 “Intelligent Piconet Forming” by Johan Rune filed on Dec. 6, 2000, which is herein incorporated by reference. In allowing the page scan transceiver to become the master at the initial contact, the master-slave switch procedure can be eliminated from the message sequence. This reversed page procedure starts like a regular page procedure initiated by the roaming unit. However, after the two initial ID packets, the FHS packet sent from the roaming unit is slightly modified (indicated FHS packet* in FIG. 8) so that it includes a request for reversal of the paging direction. Upon receiving the request for reversal of the paging direction, the Bluetooth NAP in response, sends a FHS packet to the roaming unit. Thereafter the procedure ends with an ID packet sent from the roaming unit, just as if the page procedure had been initiated by the Bluetooth NAP. Therefore, the role of the paging unit is taken over by the Bluetooth NAP and will thus become the master of the resulting connection.

As can be seen from FIG. 8, a master-slave switch procedure is not performed. Instead, after the inquiry procedure 850 and the connection establishment 860, the page scan transceiver 830 internally hands over the connection with roaming unit 810 to the traffic transceiver 820. The request for reversal of the paging direction is performed during the connection establishment 860. The modified FHS packet sent from the roaming unit 810 to the page scan transceiver 830 contains the request for reversal of paging direction. The page scan transceiver 830 then responds by sending an FHS packet to the roaming unit 810 thereby reversing the paging direction. Normal data transfer and processing is continued 870 from this point on. It should be pointed out that because a master-slave switch is not performed, all information that normally would have been transferred during the master-slave switch, and which is needed, can be transferred during the connection establishment 860.

The inclusion of two auxiliary transceivers in the NAP allows the Bluetooth NAP's main transceiver to delegate various processes to the auxiliary transceivers, thereby freeing the Bluetooth NAP main transceiver to focus more completely on the conventional functions associated with a NAP, such as processing data, traffic etc. In another exemplary embodiment, one auxiliary transceiver is used with a NAP. In this situation, the single auxiliary transceiver can perform both the inquiry scan and the page scan operations, sharing time between them as appropriate. Alternatively, the auxiliary transceiver can perform the inquiry scan operations, while the main transceiver performs/handles the page scan and other processes (e.g. connection establishment). Using one auxiliary transceiver may not always be as efficient as using two auxiliary transceivers, but it would be more cost efficient.

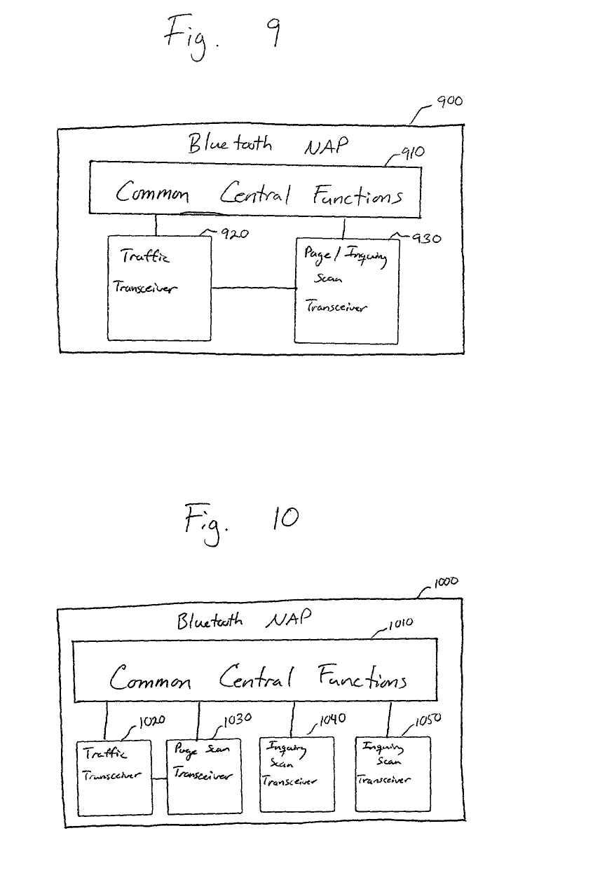

FIG. 9 illustrates an exemplary Bluetooth NAP 900 having only one auxiliary transceiver. The page/inquiry scan tranceiver 930 is connected to the common central functions 910 associated with the Bluetooth NAP 900. The page/inquiry scan transceiver 930 is also connected to the traffic transceiver 920.

In yet other embodiments of the present invention, more than two auxiliary transceivers are used. When more than two auxiliary transceivers are used, the tasks associated with each of the additional transceivers may be divided up in many different combinations. For example, as shown in FIGS. 10-12, the NAP may use these auxiliary transceivers to provide one or more inquiry scan transceivers or one or more page scan transceivers.

FIG. 10 illustrates, a Bluetooth NAP 1000 having two inquiry scan transceivers 1040, 1050 and one page scan transceiver 1030. The inquiry scan transceivers 1040, 1050 are connected to the common central functions 1010. The page scan transceiver is connected to the traffic transceiver 1020 and also to the common central functions 1010.

FIG. 11 illustrates a Bluetooth NAP 1100 utilizing two page scan transceivers 1130, 1140 and a single inquiry scan transceiver 1150. The page scan transceivers are connected to the traffic transceiver 1120. All transceivers are connected to the common central functions 1110.

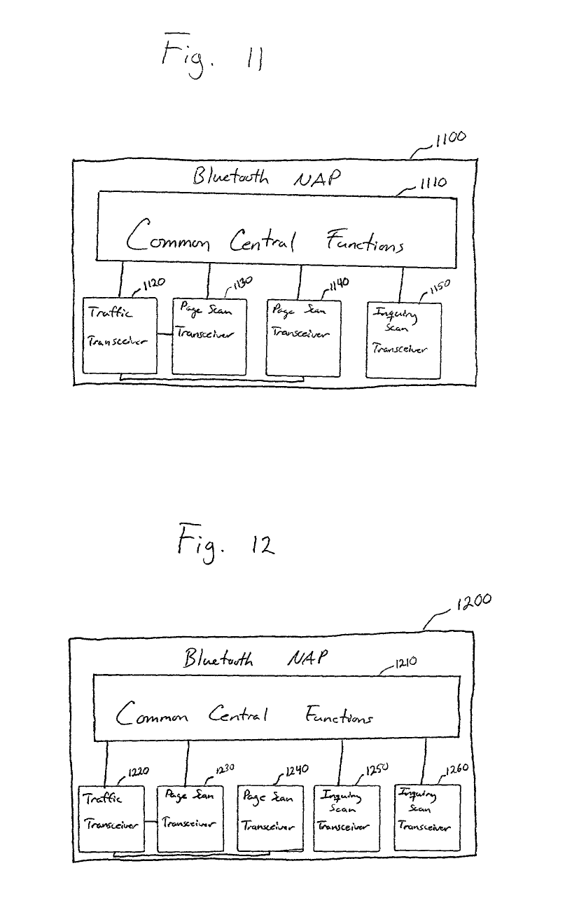

Finally, FIG. 12 illustrates a Bluetooth NAP 1200 having two page scan transceivers 1230, 1240 and two inquiry scan transceivers 1250 and 1260. The page scan transceivers are each connected to the traffic tranceiver 1220 and all tranceivers are connected to the common central functions 1210. It should be noted that numerous transceivers may be used and variations of the above figures employed.

When more than one inquiry scan transceiver is used, each transceiver should use a different clock offset in their input to the inquiry scan frequency hop sequence. This will ensure that each inquiry scan transceiver will end up in a different phase in the cycle and thus be able to scan on different frequencies. Therefore, the NAP obtains a better scan coverage as the different inquiry scan transceivers scan on different frequencies. This will increase the chance of the NAP receiving an inquiry message transmitted from a roaming unit.

The delay associated with the inquiry scan procedure is normally higher than that of the page scan procedure. Additionally, a NAP usually receives more inquiry messages than page messages. Therefore, providing several inquiry scan transceivers is more likely to decrease delay in the system than providing multiple page scan transceivers.

The present invention has been described with reference to several exemplary embodiments. However, it will be readily apparent to those skilled in the art that it is possible to embody the invention in specific forms other than those of the exemplary embodiments described above. This may be done without departing from the spirit of the invention. These exemplary embodiments are merely illustrative and should not be considered restrictive in any way. The scope of the invention is given by the appended claims, rather than the preceding description, and all variations and equivalents which fall within the range of the claims are intended to be embraced therein.

What is claimed is:

1. In a network, a Bluetooth network access point comprising:
a first transceiver, wherein the first transceiver handles traffic; and
at least one auxiliary transceiver, wherein the at least one auxiliary transceiver controls the operations associated with page scan and/or inquiry scan.

2. The Bluetooth network access point of claim 1, wherein two auxiliary transceivers are used, the first auxiliary transceiver scans for inquiry messages which are used to discover neighboring nodes and the second auxiliary transceiver scans for page messages from neighboring nodes.

3. The Bluetooth network access point of claim 1, wherein the first and auxiliary transceivers communicate with nodes using a frequency hopping communication scheme.

4. The Bluetooth network access point of claim 1, wherein the first and auxiliary transceivers are arranged such that the first and auxiliary transceivers appear to nodes communicating with them as a single network access point.

5. The Bluetooth network access point of claim 2, wherein the first auxiliary transceiver responds to inquiry messages using inquiry response messages, and
wherein the second auxiliary transceiver establishes a connection with neighbor nodes.

6. The Bluetooth network access point of claim 2, wherein after the second auxiliary transceiver establishes a connection with a neighbor node, the first transceiver communicates traffic information with the neighbor node.

7. The Bluetooth network access point of claim 1, wherein the network access point is connected to a fixed infrastructure network.

8. The Bluetooth network access point of claim 1, wherein the first transceiver and at least one auxiliary transceiver have the same Bluetooth device address (BD_ADDR).

9. The Bluetooth network access point of claim 1, wherein the first transceiver and at least one auxiliary transceiver are synchronized by the same clock.

10. In a network, a method for establishing a traffic channel between a network access point and a node, the method comprising the steps of:
scanning for inquiry messages by a first transceiver of the network access point;
receiving an inquiry message by the first transceiver from the node; and
establishing a connection between the network access point and the node, wherein after the connection is established the node communicates traffic with a second transceiver of the network access point.

11. The method of claim 10, further comprising the steps of:
receiving a page message from the neighbor node by the first transceiver; and
responding to the page message by the first transceiver, wherein the node initially establishes the connection with the first transceiver of the network access point.

12. The method of claim 10, further comprising the steps of:
receiving a page message from the neighbor node by a third transceiver of the network access point; and
responding to the page message by the third transceiver, wherein the node initially establishes the connection with the third transceiver of the network access point.

13. The method of claim 10, wherein the network access point and the node communicate using a frequency hopping scheme.

14. The method of claim 13, wherein the network access point and the node communicate in accordance with Bluetooth protocol.

15. The method of claim 10, wherein the network access point is connected to a fixed infrastructure network.

16. A method for establishing a traffic channel between a Bluetooth network access point and a node, comprising the steps of:
scanning for inquiry messages by a first transceiver;
receiving an inquiry message by the first transceiver from the node;
establishing a connection with the node by performing page scans by a second transceiver; and
transferring the established connection to a third transceiver for communicating traffic.

17. The method of claim 16, wherein the first, second and third transceivers have the same Bluetooth device address (BD_ADDR).

18. The method of claim 16, wherein the first, second and third transceivers are synchronized by the same clock.

19. The method of claim 16, wherein at least one additional transceiver is used to aid the first and/or second transceiver.

20. The method of claim 16, wherein the Bluetooth network access point is connected to a fixed infrastructure.
